(19) United States
(12) Patent Application Publication
(10) Pub. No.: US 2026/0024030 A1
(43) Pub. Date: Jan. 22, 2026

(54) DISTANCE MATRIX FOR DYNAMIC PATH SELECTION AND REDUCED TRANSIT TIME

(71) Applicant: Walmart Apollo, LLC, Bentonville, AR (US)

(72) Inventors: Jinyang Zhou, McKinney, TX (US); Zhongmin Tao, Katy, TX (US); Deepesh Kumar Rathore, McKinney, TX (US); Jiahao Zhang, Frisco, TX (US); Raisa Mukadam, Carrollton, TX (US); Karun Dhingra, Rogers, AR (US); Danielle Therese Shaw, Bentonville, AR (US); Mitchell Thomas Griffith, Garland, TX (US); Vandana Rana, Overland Park, KS (US)

(21) Appl. No.: 19/274,793

(22) Filed: Jul. 21, 2025

Related U.S. Application Data
(60) Provisional application No. 63/673,720, filed on Jul. 20, 2024.

(51) Int. Cl. G06Q 10/047; G01C 21/20; G05D 1/225; G06V 20/52

(52) U.S. Cl. CPC G06Q 10/047; G01C 21/206; G05D 1/225; G06V 20/52

(57) ABSTRACT

Examples provide a dynamic distance matrix model for optimizing routing within a retail facility and minimizing time consumed in transit. A distance manager calculates physical distance and average transit time for each path in a plurality of possible paths from a source location to a destination location within a retail facility using coordinate data, item location data and historical distance data. The shortest path is selected from the plurality of possible paths based on the physical distance and/or the average transit time for each possible path. A distance matrix is updated with the distance data for the shortest paths between selected source and destination locations in the retail facility. The distance matrix is updated in real-time based on changes in item assortment, item layout, and the locations of obstructions enabling optimized routing of users within the retail facility to minimize distance traveled and transit time.

### BACKGROUND

It is frequently necessary for employees within a large store or other retail facility to make frequent trips between various locations for many different purposes, such as restocking, order fulfillment, inventory, or other purposes. Typically, these employees rely on their personal knowledge of the store layout or static planogram data to locate items and identify the best route through the store to get from one place to another in the store. Moreover, determining how long it should take to get from one place to another may be determined based on manual measuring of distances using a measuring tape. These methods are inefficient, inaccurate, and potentially frustrating for human users, as well as wasted time spent in transit within the store while attempting to reach a desired location using incomplete information.

### SUMMARY

Some embodiments provide a system and method for dynamic distance-based routing using a distance matrix model. A distance manager component calculates dynamic distance data for each path in a plurality of possible paths between a source location and a destination location within a retail facility. The dynamic distance data includes an average walk time from the source location to the destination location and a distance between the source location and the destination location. A shortest path from the source location to the destination location is calculated using the dynamic distance data for each path. The shortest path is a path having the shortest average transit time and/or the shortest physical distance from the source location to the destination location. The dynamic distance data for the shortest path is recorded in a distance matrix. Routing instructions from the source location to the destination location via the shortest path is generated and presented to a user for routing the user to the destination location. If new data is received indicating a change in item assortment within the retail facility, layout of items within the retail facility or new obstructions within the retail facility, updated dynamic distance data is generated for each path between the source location and the destination location. The distance matrix is updated with the updated distance information. Updated routing instructions are generated for routing users to the destination location via the shortest possible path from any source location to the destination location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for routing via a shortest indoor path using a dynamically updated distance matrix.

FIG. 2 is an exemplary block diagram illustrating a system for gathering real-time distance-related data and/or identifying the shortest path between locations within a retail facility.

FIG. 3 is an exemplary block diagram illustrating a retail facility including a plurality of image capture devices for generating image data associated with a plurality of locations within the retail facility.

FIG. 4 is an exemplary block diagram illustrating a distance manager component for routing users via a dynamic distance matrix.

FIG. 5 is an exemplary flow chart illustrating operation of the computing device to identify a shortest path from a source location to a destination location.

FIG. 6 is an exemplary flow chart illustrating operation of the computing device to dynamically update a distance matrix.

FIG. 7 is an exemplary flow chart illustrating operation of the computing device to generate routing instructions and a routing map using distance data from a distance matrix.

FIG. 8 is an exemplary diagram illustrating a user device displaying routing information for routing a user from a source location to a destination location.

FIG. 9 is an exemplary diagram illustrating a user device having a user interface (UI) for displaying routing instructions to a user.

FIG. 10 is an exemplary table showing transit time differences between locations.

FIG. 11 is an exemplary table illustrating calculations of time differences between departure time and arrival time by a distance manager.

FIG. 12 is an exemplary table illustrating calculation of walk time where travel is within a single zone.

FIG. 13 is an exemplary table illustrating calculation of walk time where travel is within the same zone using calculated segment and aisle difference.

FIG. 14 is an exemplary distance matrix containing time-based distance data for location pairs within a retail facility.

FIG. 15 is an exemplary table illustrating logics for calculating feet-based in-store distances between locations.

FIG. 16 is an exemplary table illustrating calculations of feet-based distances between location pairs using coordinate data

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Stores, distribution centers (DCs), and fulfillment centers, including retail supercenters, stores of all sizes, and exclusive membership-based warehouses, pose challenges for associates, customers, and vendors due to their unfamiliarity with indoor maps and routes. Existing methods for calculating distances are designed for outdoor use and rely heavily on global positioning system (GPS) locators and world maps.

Navigating expansive retail supercenters and exclusive membership-based warehouses can be a daunting and time-consuming endeavor for associates, customers, and vendors alike, primarily due to their unfamiliarity with indoor maps and routes. Determining the distance between locations is a crucial aspect of building up familiarity, and optimizing these distances is even more complex. Current distance calculators are mainly designed for outdoor use, relying heavily on GPS locators and world maps. Consequently, this has led to most resorting to rudimentary methods like measuring distances with tape measures or other inaccurate methods.

Thus, retailers lack a distance calculation to understand the precise distance between items in a store. This is due to the difficulty of mapping and measuring a store as the layout and assortment changes. These dynamic variables have resulted in the industry avoiding these types of calculations. The lack of accurate data on the distance between locations blocks teams from surfacing relevant information at the right place and time, and leads to inefficient routing and tasking within indoor retail facilities.

Moreover, users driving forklifts are typically permitted to choose their own routes through the store when dropping off or picking up pallets in accordance with a pallet drop list. Executing the drop list in this haphazard fashion results in wasted time driving the forklift empty from one drop to another. This increases the time each forklift spends empty, without carrying a pallet or other load increasing the time it takes to move pallets as well as potentially increasing the number of forklifts required to complete tasks during each day, thereby wasting forklift resources.

Referring to the figures, examples of the disclosure enable dynamic distance calculations for routing users within an indoor space via the shortest path for reduced transit time. This enables routing users, forklifts, and/or autonomous devices via the shortest path between item locations for improved efficiency and increased user efficiency.

In some embodiments, the system provides for mapping and calculating distance within a store. A distance matrix is generated which provides mapped and calculated walkable distance between item locations, accounting for permanent obstacles. The distance matrix updates as layout and assortment changes. The distance between a source location and a destination is measured in transit time and distance for improved accuracy of calculated distances and a reduced error rate.

The system, in other embodiments, identifies the shortest path between multiple points of departure (source location) and destination locations enabling output of routing instructions along a shortest possible path. The routing instructions and/or a routing map is displayed to the user via a user interface (UI) device. This enables an improved user experience via the UI device and increased user interaction performance while further reducing the amount of time that users spend in transit between the point of departure and the destination.

Aspects of the disclosure further enable a distance matrix model that is updated dynamically using real-time image data and per-store distance data to calculate transit time and physical distance between locations for routing users more accurately and efficiently with reduced system resource usage due to reduced processor load and reduced memory consumption during routing. The computing device operates in an unconventional manner by generating routing instructions using dynamic distance matrix data to identify a shortest route between two points in an indoor space with greater speed and accuracy while reducing routing errors. In this manner, the computing device is used in an unconventional way, and allows improved accuracy in routing users with fewer errors in routing instructions which reduces resources consumed in generating and updating routing instructions where unexpected obstructions or changes in layout occur, thereby improving functioning of the underlying computing device.

Selecting the shortest path for routing forklifts further improves forklift resource usage and efficiency. Optimizing routes decreases the time forklift drivers spend driving the forklift empty (from one drop to another) by as much as thirty-nine percent and reduces the time it takes to complete the overall drop list by as much as seventeen percent, thereby reducing costs and improving operating efficiency while reducing the number of forklifts required for each store.

The system, in other embodiments, provides a cost-effective and innovative indoor distance matrix (DM). The DM is fortified with advanced statistical methods and sophisticated machine-learning models, providing a dynamic and accurate distance based matrix that encompasses all potential distances between locations within the store. The DM enables provision of more efficient routing, enabling efficiency improvement in restocking and a significant reduction in time for curbside pick-up orders. To further leverage its potential, an API service is provided in some embodiments to streamline integration across various facets of store operations and reduction in computing resource utilization in routing, improving the way retail spaces function and enhancing the overall experience for users.

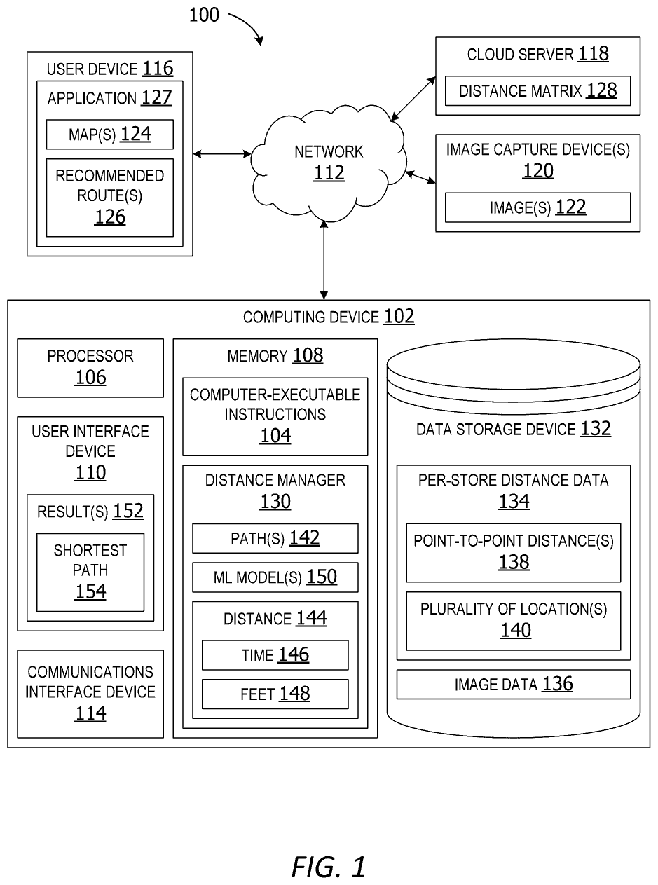

Referring again to FIG. 1, an exemplary block diagram illustrates a system 100 for routing via a shortest indoor path using a dynamically updated distance matrix. The shortest indoor path is a path having the shortest physical distance between two points and/or the shortest average transit time. The average transit time is the average time it takes for a user to walk the path, a vehicle to drive along the path, and/or a robotic device to travel along the path from a source location to a destination location. The indoor path can include paths that are complete within an indoor space of a structure, as well as paths that are partially indoors and partially outdoors. For example, an indoor space of a retail facility includes spaces within a garden center which may be partially enclosed and partially unenclosed. The indoor spaces also include areas which are outdoors but adjacent to an indoor area, such as a display on a covered porch, beneath an awning, or within an enclosed or fenced off outdoor space.

In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

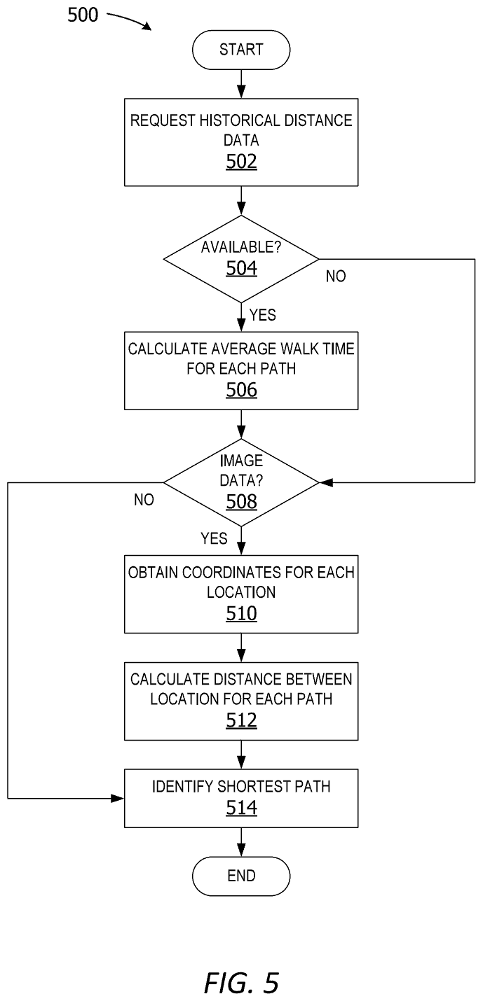

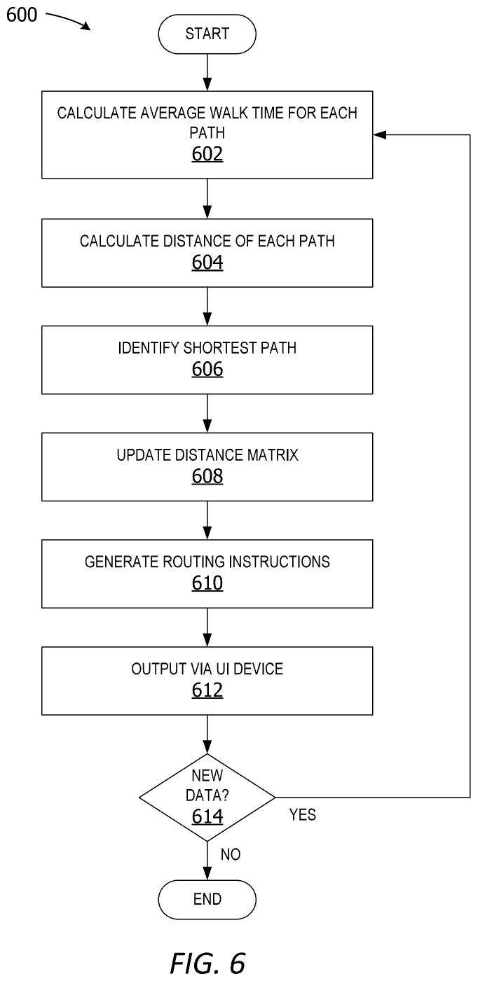

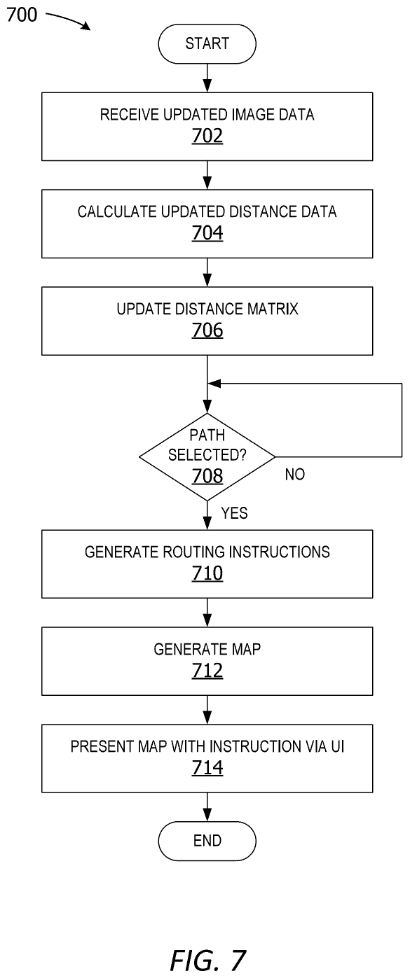

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 5, FIG. 6, and FIG. 7).

The computing device 102 further has one or more computer-readable media such as the memory 108. The memory 108 includes any quantity of media associated with or accessible by the computing device 102. The memory 108 in these embodiments is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, and/or image capture device(s) 120, can occur using any protocol or mechanism over any wired or wireless connection. In some embodiments, the communications interface device 114 is operable with short range communication technologies such as by using near-field communication (NFC) tags.

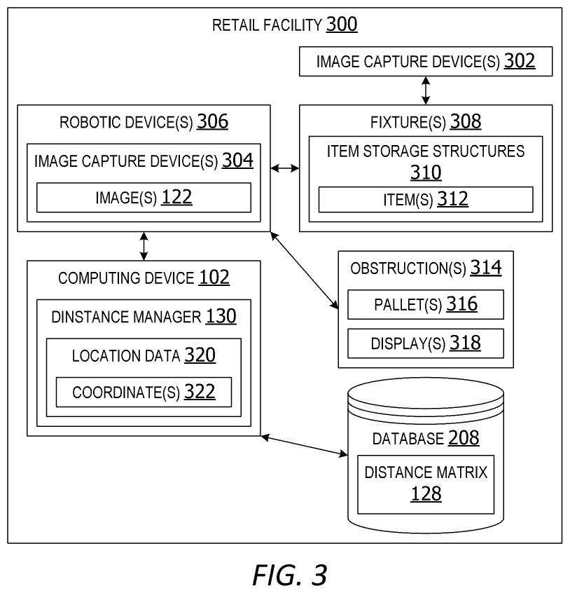

The image capture device(s) 120 represent any type of device for capturing digital image(s) 122. In this example, the image capture device(s) 120 generate image(s) 122 of items, item storage structures, fixtures, and/or obstacles within a retail facility, such as, but not limited to, the retail facility 300 in FIG. 3 below. The image capture device(s) 120 include hand-held cameras as well as cameras mounted on one or more autonomous robotic devices, as shown in FIG. 3.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device for displaying data to a user, such as, but not limited to, routing map(s) 124, recommended route(s) or other information.

In this example, the memory of the user device 116 stores applications, such as, but not limited to, the application 127. The application 127 presents the routing map(s) 124, the recommended route(s) 126 and/or other routing instructions to the user. A routing map 124 is a graphic map displayed via a graphical user interface (GUI). The routing map includes a graphical representation of a portion of an interior space and a representation of a route through the interior space from a source location to a destination location inside the retail facility. The recommended rout(s) 126 is a recommendation of a shortest path through a portion of the retail facility beginning at a source location (starting point) to a destination location (ending point).

The cloud server 118 is a logical server providing services to the computing device 102 or other clients, such as, but not limited to, the user device 116. The cloud server 118 is hosted and/or delivered via the network 112. In some embodiments, the cloud server 118 is associated with one or more physical servers in one or more data centers. In other embodiments, the cloud server 118 is associated with a distributed network of servers.

The cloud server provides services, such as, but not limited to, data storage. In this example, the cloud server 118 stores a distance matrix 128. The distance matrix 128 is a table storing distance data associated with one or more paths between one or more source-to-destination location pairs within the retail facility. The distance matrix 128 is updated dynamically in response to changes in item assortment, store layout, detection of new obstructions in one or more of the paths, changing location of obstructions, or any other changes which impact accessibility of a given path or transit time along a given path.

In this example, the distance matrix 128 is stored remotely on the cloud server 118. However, the embodiments are not limited to storing the distance matrix on a cloud server. In other embodiments, the distance matrix is stored locally on a data storage device, such as the data storage device 132.

The system 100 can optionally include one or more data storage devices, such as the data storage device 132. The data storage device 132 is a device for storing data, such as, but not limited to per-store distance data 134 and/or image data 136. The per-store distance data 134 is data associated with point-to-point distance(s) 138 between two or more locations in a plurality of location(s) 140 in an indoor space, such as a retail facility. The plurality of location(s) 140 include the locations of individual items, pallets of items, item/pallet storage locations, item displays, or any other locations within a space.

The image data 136 is data associated with image(s) 122 generated by the image capture device(s) 120. The image(s) 122 in this example are obtained from the image capture device(s) via the network 112. In other embodiments, the image(s) 122 may be transferred via a data storage device, such as, but not limited to, a flash drive.

The data storage device 132 can include one or more different types of data storage devices, such as, for example, one or more rotating disks drives, one or more solid state drives (SSDs), and/or any other type of data storage device. The data storage device 132 in some embodiments includes a redundant array of independent disks (RAID) array. In some embodiments, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 132 includes a database.

The data storage device 132 in this example is included within the computing device 102, attached to the computing device, plugged into the computing device, or otherwise associated with the computing device 102. In some embodiments, the data storage device 132 includes a remote data storage accessed by the computing device via the network 112, such as a remote data storage device, a data storage in a remote data center, or a cloud storage.

The memory 108 in some embodiments stores one or more computer-executable components, such as, but not limited to, the distance manager 130. The distance manager 130, when executed by the processor 106 of the computing device 102, calculates dynamic distance data for one or more possible path(s) 142 between a source location and a destination location within a retail facility. The distance 144 for each path is calculated as an average walk time 146 from the source location to the destination location and a distance in feet 148 between the source location and the destination location. However, the embodiments are not limited to calculating the distance 144 in feet 148. The distance 144 in other embodiments is calculated in yards, meters, or any other distance metric.

The distance manager 130 identifies a shortest path 154 in the one or more possible path(s) 142 between the two locations using the dynamic distance data for each path. The shortest path 154 is a path having the shortest average walk time, the shortest physical distance measured in feet or some other distance metric, or the path having both the shortest walk time and the shortest physical distance between the source location and the destination location. The distance manager 130 records the distance 144 in time 146 and/or feet 148 for the shortest path 154 in the distance matrix 128. In other embodiments, the system records the distance data for every possible path between each source-to-destination location pair within the distance matrix.

In some embodiments, the distance manager 130 generates routing instructions for traveling from the source location to the destination location along the shortest path 154 and outputs the instructions to the user via a user interface, such as, but not limited to, the user interface device 110 and/or a user interface associated with the user device 116.

The distance manager 130, in other embodiments, obtains real-time image data 136 associated with an obstruction within the shortest path 154 or any other path between any two points from the image capture device(s) 120. The distance manager 130 calculates updated dynamic distance data for each possible path between the source location and the destination location. The distance manager 130 identifies an updated shortest path in the plurality of possible paths using the updated dynamic distance data. The updated shortest path can be the same path or a new path between the two locations. The distance manager 130 records the updated distance data associated with the updated shortest path within the distance matrix 128 in real-time to provide up-to-date information on any permanent or temporary obstructions which may be impeding travel via one or more of the paths in the retail facility.

The distance manager 130 uses two kinds of distance matrix models for calculating distances between locations, which is suitable for different use cases. If historical travel data with time difference is given, then time-based distance matrix model is utilized. The time-based distance matrix model refers to methodologies for determining transit time between two locations. If one knows the exact x-coordinates and y-coordinates for each location, then feet-based distance matrix model is utilized. The feet-based distance matrix model refers to formulae and methodologies applied by the distance manager to determine physical distance between two locations as measured in feet or any other distance metric, such as meters, yards, etc.

In some embodiments, the distance manager 130 includes one or more machine learning (ML) model(s) 150, such as, but not limited to, a random forest regression model. The ML model(s) 150 apply computer vision analysis to the image data 136 to detect and recognize items, structures, and potential obstacles within the image data 136. Computer vision object recognition can be used to analyze images of products and other objects within a store, warehouse, distribution center or other retail facility to automatically identify products, signs, location tags, shelving, and other objects using input images of the objects. The object recognition results are used to further update the distance calculations and/or selection of the optimal path from the source location to the destination location. The shortest path 154 result(s) 152 are presented to the user via the user interface device 110 and/or the user device 116.

In these embodiments, the image(s) 122 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 122.

In other embodiments, lidar is used to calculate more accurate and reliable coordinates of locations in a store or other retail facility. In these examples, lidar maps are used to calculate the coordinates.

The distance manager 130 provides distance data and enhanced routing which improves store operation efficiency and improves customer experience in large retail spaces. It calculates distances within the store in terms of time-consumption (seconds) or real distance (feet) using advanced statistical methods and machine learning models. The time-consumption distance matrix utilizes historical records, mathematical equations, and optimizers, while the feet-based distance matrix uses pixel-based coordinates data generated through computer vision techniques.

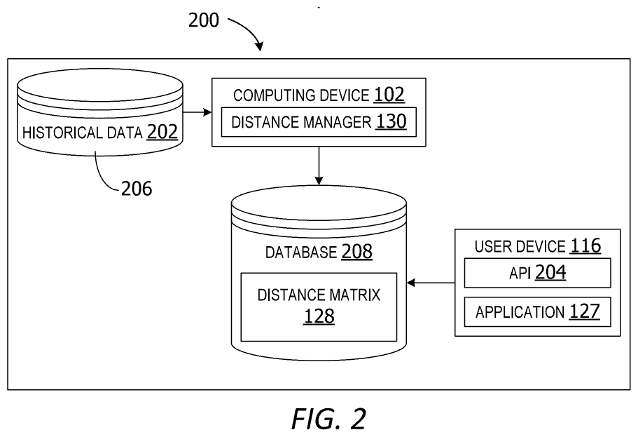

FIG. 2 is an exemplary block diagram illustrating a system 200 for gathering real-time distance-related data and/or identifying the shortest path between locations within a retail facility. In this example, the distance manager 130 on the computing device 102 obtains historical data 202 from a database 206 via a wired or wireless connection. The historical data 202 includes historical distance data associated with transit between two locations (points) within the retail facility. The distance data includes data associated with a human walking along a path, a forklift or other vehicle driving along the path, and/or a robotic device moving along the path.

The distance manager 130 updates a distance matrix 128 with distance data associated with distances between each location in each pair of locations. In this example, the distance matrix 128 is stored on a database 208 accessible to the computing device via a wired or wireless communication network. The database 206 and the database 28 are stored on one or more data stores, such as, but not limited to, the data storage device 132 in FIG. 1 and/or a data storage device associated with the cloud server 118 in FIG. 1.

In this example, a user accesses the distance data provided by the distance matrix 128 via an application 127. The application 127 connects to the database 208 to retrieve distance information from the distance matrix and/or obtain routing information from the distance manager 130 via an application programming interface (API) 204. The API 204 provides access to the underlying distance matrix data, which can be accessed and utilized by various applications. Moreover, the API is scalable.

Referring now to FIG. 3, an exemplary block diagram illustrating a retail facility 300 including a plurality of image capture devices for generating image data associated with a plurality of locations within the retail facility 300. The retail facility 300 is any type of building or structure within a retail environment. In this example, the retail facility 300 is a store. The retail facility 300 includes stores, warehouses, fulfillment centers, and/or distribution centers. Stores include small stores, mid-sized stores, as well as retail supercenters and exclusive membership warehouses.

The distance manager 130 obtains image(s) 122 from one or more image capture devices, such as, but not limited to, the one or more image capture device(s) 302 and/or the image capture device(s) 304. The one or more image capture device(s) 302 include cameras which are hand-held or stationary, such as cameras mounted on a ceiling, wall, item storage structure, or other location. The one or more image capture device(s) 304 includes one or more cameras mounted to one or more autonomous robotic device(s) 306.

The image capture devices capture images of fixture(s) 308, such as, but not limited to, support posts or other immovable objects. The fixture(s) 308 can also include movable objects, such as item storage structures 310. An item storage structure is a structure for storing one or more item(s) 312, such as a bin, shelving, display case, refrigerated display case, freezer, or any other type of item storage structure. The item(s) 312 include individual items as well as cases or pallets of items.

The image(s) 122 in some embodiments include images of obstruction(s) 314. An obstruction includes permanent obstructions as well as temporary obstructions. An obstruction is an object that is completely or partially blocking a walkway, accessway or other portion of a path. An obstruction can include one or more pallet(s) 316, one or more display(s) 318, as well as any other type of obstruction within a pathway. The display(s) 318 include end-cap displays, aisle displays, clothing racks, advertising displays which may be placed within the store.

The distance manager 130 analyzes the image(s) to generate location data 320 for objects within the store, such as the fixture(s) 308, item storage structure(s) 310, display(s) 318, pallet(s) 316, and other obstruction(s) 314. The location data 320 includes the coordinate(s) 322 of one or more locations, such as the location of an item, location of a pallet, location of an obstruction, etc. The coordinate(s) 322 include the x-coordinate and y-coordinate for each location. The coordinates are obtained from the image data.

In this example, the image(s) 122 are transmitted from the image capture device(s) to the computing device 102 and/or a cloud storage, such as, but not limited to, the cloud server 118 in FIG. 1. The distance manager 130 analyzes the image(s) 122 to determine the coordinate(s) of locations associated with objects, such as the fixtures and obstructions. The coordinate(s) 322 are used by the distance manager to calculate the physical distance between two locations within the retail facility 300. The distance matrix 128 on the database 208 is updated with the distance data calculated based on the coordinate(s) 322.

If the coordinates cannot be obtained from image data or if the image data for one or more of the locations is unavailable, a random forest regression model can be utilized to complete the missing coordinates. The random forest regression model is a machine learning model, such as, but not limited to, a model in the one or more ML models 150 in FIG. 1. In one example, if coordinates can be obtained for a location designated “H1-1” and a location designated “H1-3, which is (x₁, y₁) and (x₃, y₃) respectively, but “H1-2” coordinates are not accessible, then the random forest regression model can recover the coordinates for “H1-2”, which is as follows:

$$( ( {x}_{2} , {y}_{2} ) ) = ( ( {x}_{1} + {x}_{3} ) / 2 , ( {y}_{1} + {y}_{3} ) / 2 ) .$$

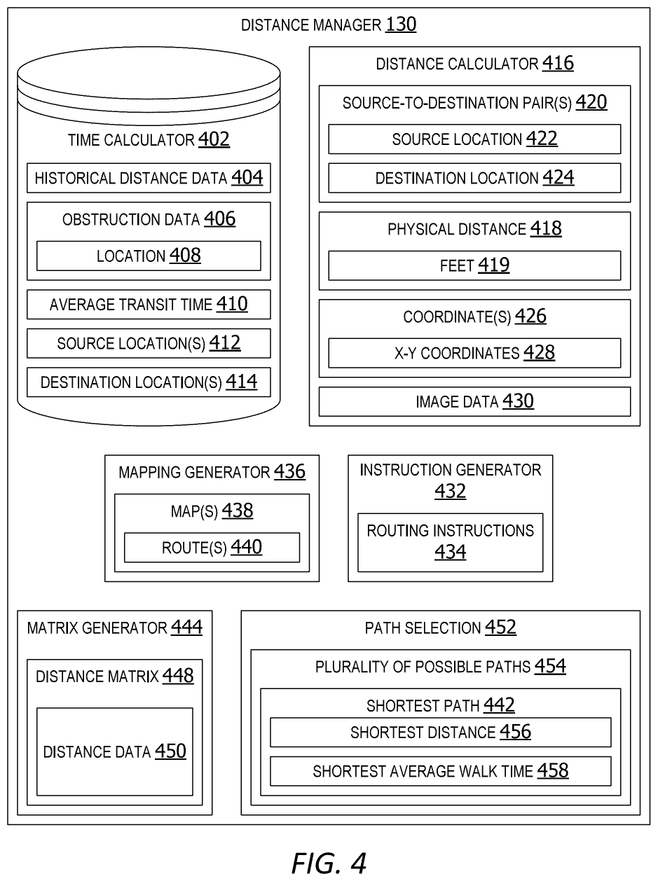

FIG. 4 is an exemplary block diagram illustrating a distance manager 130 for routing users via a dynamic distance matrix. In some embodiments, a time calculator 402 is a software component that utilizes historical distance data 404 and obstruction data 406 including a location 408 of path obstructions to generate an average transit time 410 from one or more source location(s) 412 to one or more destination location(s) 414. The average transit time 410 includes the average time for a human to walk from a starting point to a destination point, the average time to drive a forklift by a human driver from a source location (starting point) to a destination, and/or the average time required for a robotic device to traverse a path from a source location to a destination location. The time calculator, in some embodiments, includes a machine learning model, such as but not limited to, the ML model(s) 150 in FIG. 1.

A distance calculator 416 is a software component that calculates physical distance 418 for each source-to-destination pair in one or more source-to-destination pair(s) 420. A source-to-destination pair includes a source location 422 (starting point) and a destination location 424 (ending point). The physical distance 418 is provided in a distance metric, such as feet 419.

In this example, the distance calculator 416 utilizes image data 430 to determine the coordinate(s) 426 of the source location 422 and the destination location 424 within the store. The coordinate(s) 426 include x-y coordinates 428. In some embodiments, the distance calculator includes a machine learning model, such as, but not limited to, the ML model(s) 150 in FIG. 1.

An instruction generator 432 is a software component that generates routing instructions 434 for routing a user, forklift driver, or robotic device along the shortest path 442. The routing instructions 434 are optionally presented to the user via a user interface, such as the user interface device 110 in FIG. 1.

A mapping generator 436 is a software component for generating one or more graphical map(s) 438 visualizing one or more route(s) 440 from a source location to a destination location along the shortest path 442. The map(s) 438 include one or more graphical representations of the shortest path through a portion of the retail facility, such as the one or more map(s) 124 in FIG. 1. The map(s) 438 are optionally presented to a user via a user interface, such as but not limited to, the user interface device 110 in FIG. 1 and/or via a UI of the user device 116 in FIG. 1.

In some embodiments, the distance manager 130 includes a matrix generator 444 or generating a distance matrix 448 and/or updating the distance matrix 448 in real time. The distance matrix 448 is a table containing distance data 450, such as the physical distance 418 between the source location and the destination location and/or the average transit time 410 for traversing a path from the source location to the destination location. The distance matrix is a table, such as, but not limited to, the distance matrix 128 in FIG. 1.

A path selection 452 is a software component for selecting the shortest path 442 from a plurality of possible paths 454 between the source location and the destination location. The shortest path 442 is the path having the shortest distance 456 and/or the shortest average walk time 458 of all the path is the plurality of possible paths 454.

FIG. 5 is an exemplary flow chart illustrating operation of the computing device to identify a shortest path from a source location to a destination location. The process shown in FIG. 5 is performed by a distance manager component, executing on a computing device, such as the computing device 102 or the user device 116 in FIG. 1.

The process begins by requesting historical distance data at 502. The historical distance data is data describing known transit time's for walking or traversing a path between two locations, such as, but not limited to, the historical data 202 in FIG. 2. The historical distance data is requested from a data store, such as, but not limited to, the data storage device 132 in FIG. 1 and/or the database 206 in FIG. 2. In other embodiments, the historical distance data is obtained from a cloud server, such as, but not limited to, the cloud server 118 in FIG. 1. A determination is made whether the historical distance data is available at 504. If yes, the distance manager calculates average walk time for each path at 506. The distance manager determines if image data is available for the source location and/or the destination location at 508. If yes, the system determines whether coordinates are obtained for each location at 510. If the coordinates are not obtained from the image data, a random forest regression model is applied to complete the missing coordinates at 511. The coordinates include x-coordinates and y-coordinates for each location. If the coordinates are obtained using computer vision analysis of the image data at 510 or completed using the model at 511, the distance manager calculates the distance between each location for each path at 512. The distance manager identifies the shortest path by comparing the physical distance and/or the average walk time for each path at 514. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to dynamically update a distance matrix. The process 600 shown in FIG. 5 is performed by a distance manager component, executing on a computing device, such as the computing device 102 or the user device 116 in FIG. 1.

The process begins by calculating the average walk time for each path in a plurality of paths between two locations at 602. The distance manager calculates distance for each path at 604. The distance manager identifies the shortest path at 606 using the distance and/or average walking time. The distance manager updates the distance matrix with the distance data for the shortest path at 608. The distance manager generates routing instructions for routing the user along the shortest path at 610. The distance manager outputs the routing instructions via a UI device at 612. The UI device is a device such as, but not limited to, the user interface device 110 in FIG. 1. A determination is made whether new data associated with changes in item assortment, layout or obstructions is received at 614. If yes, the system iteratively executes steps 602 through 614 to update the distance matrix in real-time until no new data is received. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to generate routing instructions and a routing map using distance data from a distance matrix. The process 700 shown in FIG. 7 is performed by a distance manager component, executing on a computing device, such as the computing device 102 or the user device 116 in FIG. 1.

The process begins by receiving updated image data at 702. The image data is received from an image capture device, such as, but not limited to, the one or more image capture device(s) 120 in FIG. 1, the image capture device(s) 302 in FIG. 3, and/or the image capture device(s) 304 in FIG. 3. The distance manager calculates updated distance data at 704 using the updated image data. The distance manager updates the distance matrix with the updated distance data at 706. The distance manager determines whether a shortest path is selected at 708. If yes, the distance manager generates routing instructions for routing the user along the shortest path at 710. The distance manager generates a map at 712. The map includes a graphical representation of the shortest path through a portion of an indoor space, such as, but not limited to, the one or more map(s) 124 in FIG. 1 and/or the one or more map(s) 438 in FIG. 4. The distance manager presents the map with the instructions via a UI at 714. The UI is a device for outputting data to a user, such as, but not limited to, the user interface device 110 in FIG. 1. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

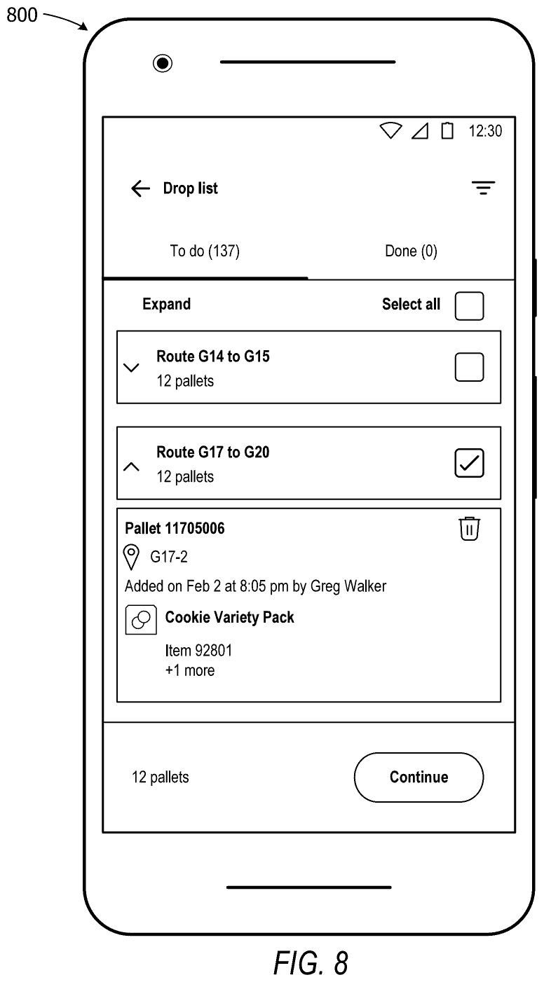

FIG. 8 is an exemplary diagram illustrating a user device 800 displaying routing information for routing a user from a source location to a destination location. In this example, the user is selecting a drop list for a dozen pallets to be picked up at a source location and moved to a destination location.

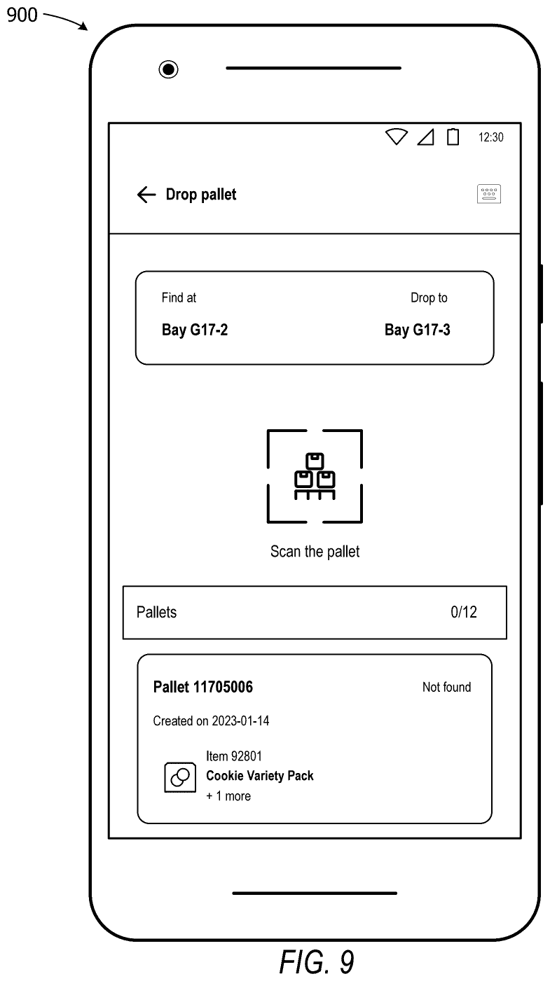

FIG. 9 is an exemplary diagram illustrating a user device 900 having a user interface (UI) for displaying routing instructions to a user. In this example, the UI is providing information regarding the source location at which a given pallet can be found and a destination location where the pallet should be delivered.

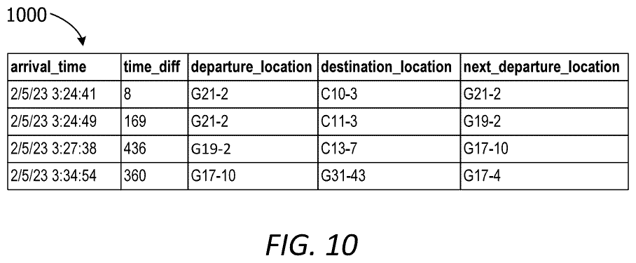

FIG. 10 is an exemplary table 1000 showing transit time differences between locations. In some embodiments, the locations of items include an identification of a zone, aisle, and aisle segment. A zone is an area of a store including multiple aisles. An aisle is a customer facing portion of shelving for displaying items. A walkway between two rows of shelves enables a customer walking down the walkway to view items on two aisles, the aisle to the right and the aisle to the left. A segment is a portion of an aisle. In other words, a row of shelving making up the aisle is made up of equally sized smaller shelving portions referred to as segments. A segment may include a portion of a shelving unit or an entire shelving unit. The aisle may include a single shelving unit or multiple shelving units arranged side-by-side. A shelving unit, such as a gondola shelf, enables items to be displayed on each side of the gondola shelving unit, forming two different aisles. The system assumes that all the aisles in the same zone are parallel and the distance between each aisle is the same. The system also assumes that the distance between each segment in the same aisle is the same (uniform distance).

For example, a location designated as “B21-5” indicates an item location in segment 5 of aisle 21 in zone B. Likewise, the location “G5-9” indicates an item location in segment 9 of aisle 5 within zone G. The time it takes to travel from one location to another can be deduced in some embodiments by subtracting the time stamp for departure from the source location from the timestamp for arrival at the destination location. For example, if a user leaves location “H1-1” at 3:24:41 and arrives at the destination location “H1-5” at 3:24:48, then the time it takes to walk from the source location to the destination location is approximately seven seconds. The seven seconds is the time difference between the arrival time and the departure time.

In this example, the distance manager uses timestamp data provided in the table 1000 to calculate all distances between departure and destination locations. Due to the limitation of pallet drop data, the table 1000 only provides one timestamp information, which is the arrival time at the departure location. The lack of arrival time of the destination location prevents the distance manager from easily and directly calculating the time consumption for walking from the source location to the destination location. Here, the system employs a scientific computing method to calculate the time consumption by only knowing the departure time. This method also has the capability to estimate the time consumption between any locations in one certain zone by sorting the timestamps first and then calculating the time difference between each departure location and each arrival/destination location, as shown in the table 1000.

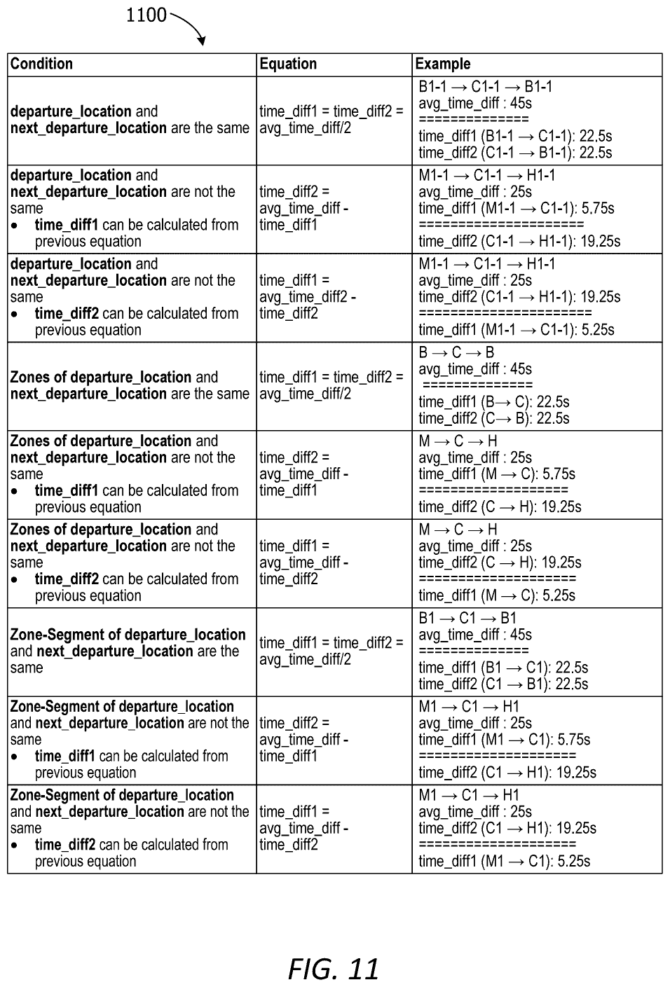

The table 1100 shown in FIG. 11 further illustrates various methods for calculations of time differences between departure time and arrival time by a distance manager. As shown below, there are multiple methods and formulas for accurately calculating time-consumed data by the distance manager.

In some embodiments, if travel is from one zone to another, the distance manager uses the average segment time difference where the segment to segment time difference is known. Otherwise, the distance manager uses the average zone time difference.

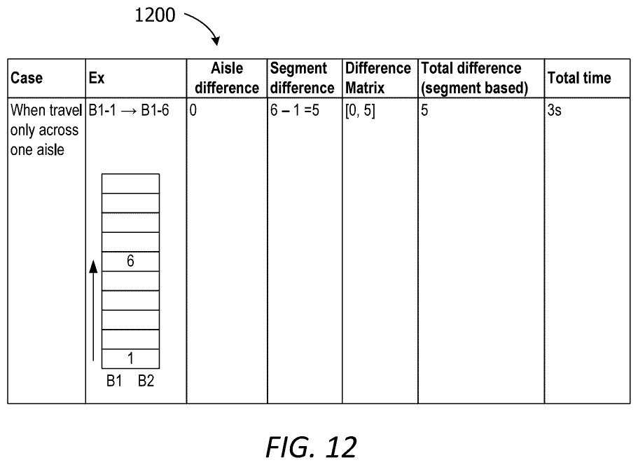

FIG. 12 is an exemplary table 1200 illustrating calculation of walk time where travel is within a single zone. In this example, a user is traveling only across a single aisle, from location B1-1 to segment B1-6. In other words, all travel in this example is within zone B and aisle 1. The travel difference is from segment one to segment five. The total travel is across five segments. If the time it takes to traverse one segment is known and all segments are the same size, then the time to traverse five segments can be determined. In this example, the total time to traverse five equal sized segments is determined to be approximately three seconds.

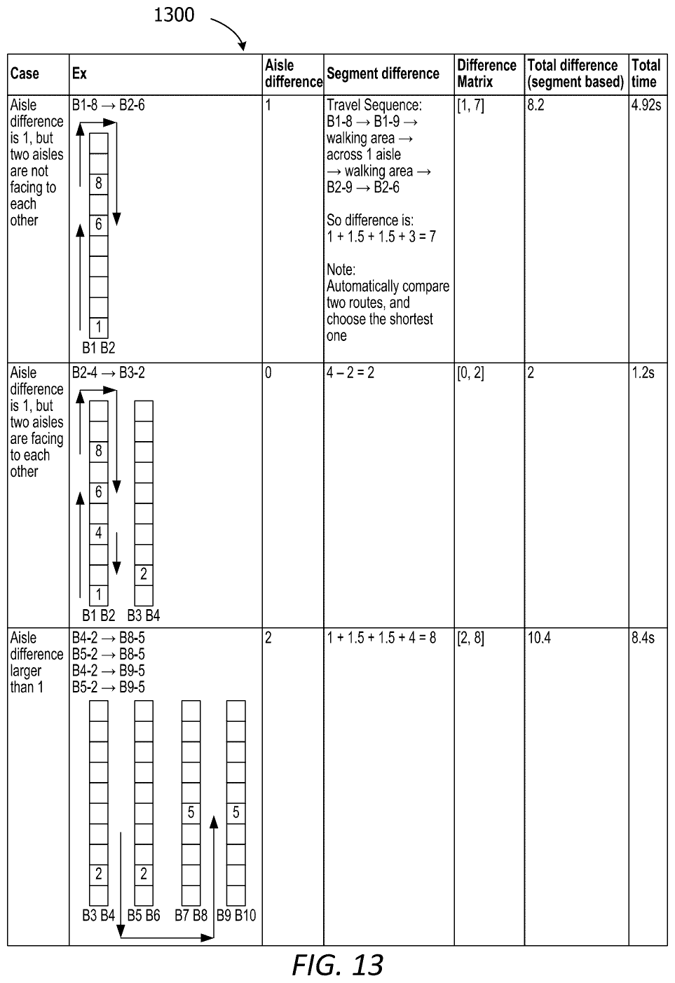

FIG. 13 is an exemplary table 1300 illustrating calculation of walk time where travel is within the same zone using calculated segment and aisle difference. In this example, time differences are calculated where the path is from a source location on a first aisle and the destination location is on a different aisle in the same zone.

After calculating the time differences (difference matrix), the distance manager uses the following method to calculate single segment/aisle time consumption. Let

$$A = [ {A}_{1} , {A}_{2} , 1 ]$$

where A_1 is the aisle difference matrix, A_2 is the segment difference matrix, and A_3 is miscellaneous (pallet pick up and drop off, pallet scan, . . . ), so all 1. Let b be the given transaction time matrix. Let

$$x = [ {x}_{1} , {x}_{2} , {x}_{3} ]$$

where x_1 is transaction time on aisle level, x_2 is transaction time on segment level, and x_3 is other time (pallet pick up and drop off, pallet scan, . . . ). The distance manager can solve for x by

$$x = arg {min}_{x} \sum {( Ax - b )}^{2}$$

$$where$$

$$x >= 0$$

to get single-segment and single-aisle time difference coefficient. Then all time difference within the zone can be calculated by the following:

$$[ {A}_{1} , {A}_{2} ] * [ segment difference , aisle difference ]$$

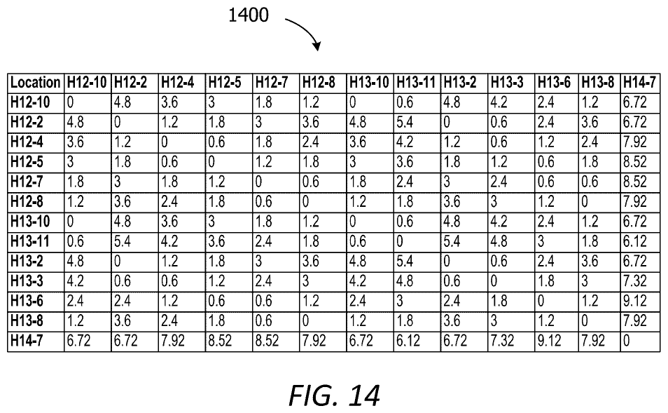

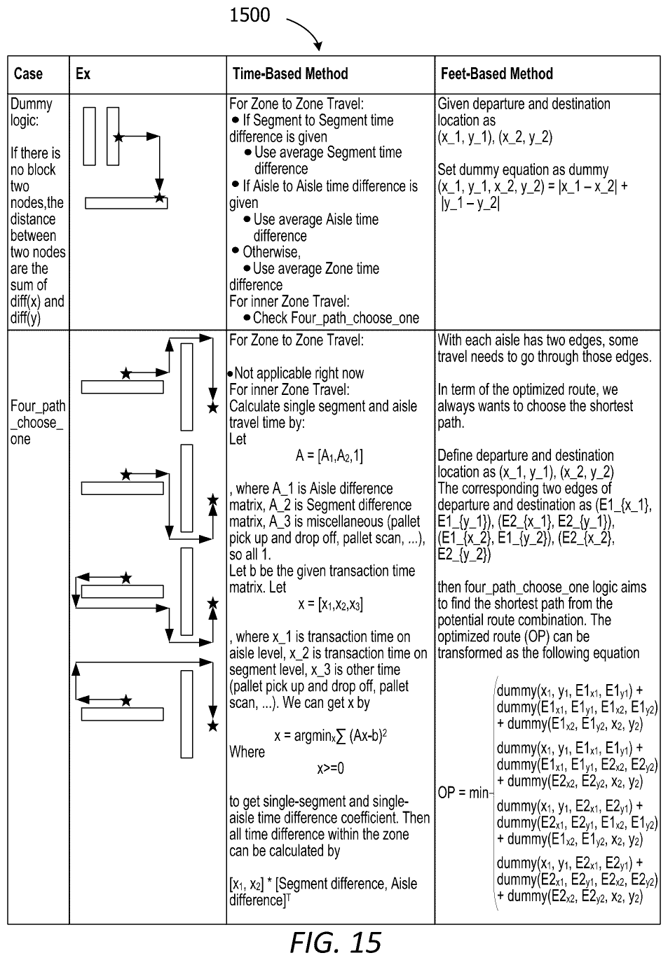

FIG. 14 is an exemplary distance matrix 1400 containing time-based distance data for location pairs within a retail facility. The format of this distance matrix 1400 is a symmetric matrix and the size of the matrix is (x, x) where x is the number of locations in each retail facility. Each element of the matrix represent the distance between the head of row (one location) and the head of column (another location). Likewise, FIG. 15 is an exemplary table 1500 illustrating logics for calculating feet-based in-store distances between locations.

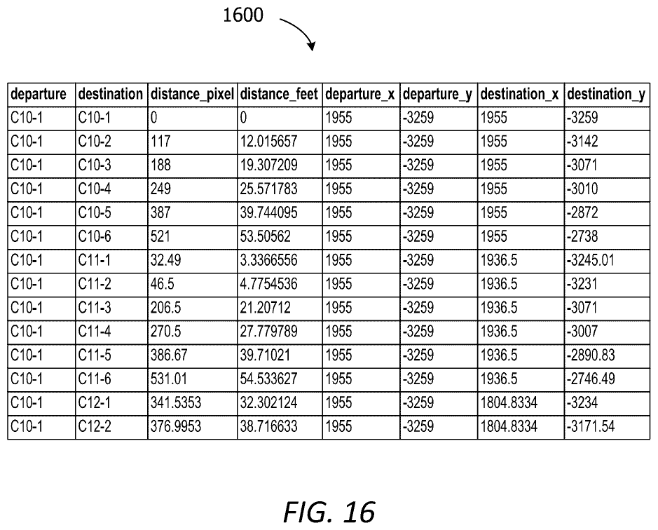

FIG. 16 is an exemplary table 1600 illustrating calculations of feet-based distances between location pairs using coordinate data. Instead of a two dimensional (2-D) table, the format of this distance matrix is a comprehensive table that lists the distance in feet between every possible combination of departure and destination locations. This table aims to additionally contain the x and y coordinates of all locations in reference to computer vision object detection.

In some embodiments, the distance manager reduces forklift empty time by optimizing routing and selection of the shortest path using average transit times and physical distance for source-to-destination locations within a retail facility. The distance matrix plays a distinctive role in route-related projects, as optimizing routes requires precise knowledge of the distances between locations. Utilizing the distance matrix enhances the efficiency of route optimization through various project examples.

By using the route optimization method, which is based on the dynamic distance matrix, the system decreases the travel time needed to fulfill orders, and the test results show, the travel time using route optimization method are decreased significantly on optimized routes.

### Additional Examples

In some embodiments, a distance matrix model is a table that uses image data XY coordinates obtained from an image capture device on a robotic device within the retail facility to map the distances (shortest path) between every source and destination combination (item location to item location) in the store. The system calculates the walkable distances between locations. When there is a clear walkable path between locations, the distance is the sum of the difference in X and difference in Y. When there are multiple paths between locations, the system calculates the possible paths and choose the shortest one. With a mapping of the inside of the building, and a knowledge of all locations, the system routes associates along the shortest paths between locations within the retail facility and provides location-based recommendations.

In other embodiments, the distance manager uses either pallet drop work list data or image data XY coordinates to map the distances (shortest path) between every source and destination combination (bay to bay) in a retail facility. The distance manager calculates two different distances, time-consumption based (average walking time) distance and real-feet based distance. The distance manager calculates the walkable distances to enrich the limited time-consumption data and intelligently calculates in-store distances, based on graph theory and store operation data, such as planogram data, including item layout and assortment.

In other embodiments, the distance manager receives inputs, including source data and third party data, in addition to the image data, planogram data, and historical distance/time-consumption data. The distance manager performs outlier removal. The distance manager performs parallel aisle detection to identify parallel aisles in the store, blocking aisle detection to detect storage structures that are perpendicular or having other non-parallel positioning, and shortest path distance detection to identify the shortest path in the plurality of paths between two locations. The shortest path data is used to generate the distance matrix.

For the time-consumption distance matrix, the distance manager processes historical records data and applies custom-designed mathematical equations, graph theories, and optimizers to accurately impute distances in seconds for all conceivable departure and destination location combinations. This versatile approach caters to a wide variety of use cases and accommodates different modes of transportation within the store, such as walking or driving forklifts. Conversely, the feet based distance matrix harnesses pixel-based coordinates data generated through computer vision techniques and employs robust statistical methods and machine learning models to effectively detect outliers and impute missing data. This approach strives to standardize and generalize distances for common use, free from any constraints.

In other embodiments, the system determines the distance between points/items in a store depending on the locations, aisles, and other obstructions. The system updates the distance matrix as the layout and assortment of items changes. The system measures the transit time (average walk time), and distance (in feet) required to travel from one point to another within the retail facility. This information is used to calculate the shortest route between two points, thereby decreasing transit time.

Alternatively, or in addition to the other embodiments described herein, examples include any combination of the following:
generate updated routing instructions for traveling from the source location to the destination location along the updated shortest path using the updated distance data;
generate a routing map including the shortest path within the retail facility;
output the routing map to a user via a user interface device for routing the user to the destination location from the source location in a shortest walking distance or within a shortest transit time;
generate driving instructions for driving a forklift along the shortest path within the retail facility;
output the driving instructions to a user device for routing the forklift to the destination location from the source location with a shortest driving distance or within a shortest transit time;
generate instructions for directing a robotic device along the shortest path within the retail facility;
transmit the instructions to the robotic device via a network, wherein the instructions route the robotic device along the shortest path within the retail facility from the source location to the destination location with a shortest distance or within a shortest transit time;
calculate the average walk time between the source location and the destination location using historical distance data associated with walkable distances between a pair of reference points within the retail facility;
calculate the distance between the source location and the destination location in feet using coordinate data for the source location and the destination location;
calculating an average walk time from a source location to a destination location associated with each path in a plurality of possible paths between the source location and the destination location within a retail facility using per-store distance data, the per-store distance data comprising historical distance data;
calculating a physical distance between the source location and the destination location using a set of coordinates for the source location and a set of coordinates for the destination location;
identifying a shortest path in the plurality of possible paths using the calculated average walk time and the calculated physical distance associated with each path, the shortest path comprising a path having at least one of a shortest average welk time or a shortest distance between the source location and the destination location;
generating routing instructions for traveling from the source location to the destination location along the shortest path, wherein the routing instructions are presented to a user via a user interface device;
obtaining real-time image data associated with a new obstruction within the shortest path from an image capture device;
calculating updated average walk time and an updated physical distance associated with each path dynamic distance data for each path in the plurality of possible paths between the source location and the destination location using the real-time image data;
identifying an updated shortest path in the plurality of possible paths using the updated average walk time and the updated physical distance associated with each path;
recording updated distance data associated with the updated shortest path within the distance matrix;
generating updated routing instructions for traveling from the source location to the destination location along the updated shortest path, the updated routing instructions including a map;
presenting the map to a user via a user interface device, wherein the map includes a graphic representation of the updated shortest path within the retail facility directing the user to travel from the source location to the destination location along the updated shortest path;
performing computer vision object recognition analysis by a machine learning model to identify the new obstruction using the real-time image data;
identifying a plurality of source-to-destination pairs within the retail facility;
calculating the average walk time and physical distance between each path in a plurality of paths corresponding to each source-to-destination pair in the plurality of source-to-destination pairs;
selecting a shortest path from the plurality of paths for each source-to-destination pair in the plurality of source-to-destination pairs;
recording the average walk time and the physical distance associated with the selected shortest path for each source-to-destination pair in the distance matrix;
obtaining image data from a plurality of image capture devices associated with a plurality of robotic devices within the retail facility, wherein the image data is analyzed to identify permanent obstructions and temporary obstructions in real-time;
generating distance data associated with a plurality of shortest paths for traveling from a selected source location to a plurality of different destination locations within the retail facility;
updating the distance matrix with the distance data for each source-to-destination pair associated with the source location and the plurality of different destination locations, wherein the distance data comprises the average walk time and the physical distance calculated for each source-to-destination pair;
generating distance data associated with a plurality of shortest paths for traveling from a plurality of different source locations to a selected destination location within the retail facility; and
updating the distance matrix with the distance data for each source-to-destination pair associated with the plurality of different source locations and the selected destination location, wherein the distance data comprises the average walk time and the physical distance calculated for each source-to-destination pair.

Examples provide a dynamic distance matrix model for optimizing routing within a retail facility and minimizing time consumed in transit. A distance manager calculates physical distance and average transit time for each path in a plurality of At least a portion of the functionality of the various elements in FIG. 1, FIG. 2, FIG. 3, and FIG. 4 can be performed by other elements in FIG. 1, FIG. 2, FIG. 3 and FIG. 4, or an entity (e.g., processor 106, web service, server, application program, computing device, etc.) not shown in FIG. 1, FIG. 2, FIG. 3, and/or FIG. 4.

In some embodiments, the operations illustrated in FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of improved routing using a distance matrix model, the method comprising calculating an average walk time from a source location to a destination location associated with each path in a plurality of possible paths between the source location and the destination location within a retail facility using per-store distance data, the per-store distance data comprising historical distance data; calculating a physical distance between the source location and the destination location using a set of coordinates for the source location and a set of coordinates for the destination location; identifying a shortest path in the plurality of possible paths using the calculated average walk time and the calculated physical distance associated with each path, the shortest path comprising a path having at least one of a shortest average welk time or a shortest distance between the source location and the destination location; generating routing instructions for traveling from the source location to the destination location along the shortest path, wherein the routing instructions are presented to a user via a user interface device; obtaining real-time image data associated with a new obstruction within the shortest path from an image capture device; calculating updated average walk time and an updated physical distance associated with each path dynamic distance data for each path in the plurality of possible paths between the source location and the destination location using the real-time image data; identifying an updated shortest path in the plurality of possible paths using the updated average walk time and the updated physical distance associated with each path; and recording updated distance data associated with the updated shortest path within the distance matrix.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in other embodiments, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for routing using a dynamic distance matrix. For example, the elements illustrated in FIG. 1, FIG. 2, FIG. 3, and FIG. 4, such as when encoded to perform the operations illustrated in FIG. 5, FIG. 6, and FIG. 7, constitute exemplary means for calculating an average walk time from a source location to a destination location associated with each path in a plurality of possible paths between the source location and the destination location within a retail facility using per-store distance data, the per-store distance data comprising historical distance data; exemplary means for calculating a physical distance between the source location and the destination location using a set of coordinates for the source location and a set of coordinates for the destination location; exemplary means for identifying a shortest path in the plurality of possible paths using the calculated average walk time and the calculated physical distance associated with each path, the shortest path comprising a path having at least one of a shortest average welk time or a shortest distance between the source location and the destination location; exemplary means for generating routing instructions for traveling from the source location to the destination location along the shortest path, wherein the routing instructions are presented to a user via a user interface device; exemplary means for obtaining real-time image data associated with a new obstruction within the shortest path from an image capture device; exemplary means for calculating updated average walk time and an updated physical distance associated with each path dynamic distance data for each path in the plurality of possible paths between the source location and the destination location using the real-time image data; exemplary means for identifying an updated shortest path in the plurality of possible paths using the updated average walk time and the updated physical distance associated with each path; and exemplary means for recording updated distance data associated with the updated shortest path within the distance matrix.

Other non-limiting examples provide one or more computer storage devices having a first computer-executable instructions stored thereon for providing a dynamic distance matrix for routing users within an indoor retail facility. When executed by a computer, the computer performs operations including obtaining image data associated with a plurality of obstructions within a retail facility; identifying a location of each obstruction in the plurality of obstructions using the image data and item assortment data; calculating dynamic distance data for each path in a plurality of possible paths between a source location and a destination location within a retail facility using per-store distance data and the location of each obstruction in the plurality of obstructions, the dynamic distance data comprising an average walk time from the source location to the destination location and a distance between the source location and the destination location; identifying a shortest path in the plurality of possible paths using the dynamic distance data for each path, the shortest path comprising a path having at least one of a shortest average welk time or a shortest distance between the source location and the destination location; recording distance data associated with the shortest path within a distance matrix; generating routing instructions for traveling from the source location to the destination location along the shortest path using the distance data in the distance matrix; and providing the routing instructions to a user via a user interface device, wherein the user is routed from the source location to the destination location along the shortest path via the routing instructions.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic distance-based routing using a distance matrix, the system comprising:
a processor; and
a computer-readable medium storing instructions that are operative upon execution by the processor to:
calculate dynamic distance data for each path in a plurality of possible paths between a source location and a destination location, the dynamic distance data comprising an average walk time from the source location to the destination location and a distance between the source location and the destination location;
identify a shortest path in the plurality of possible paths using the dynamic distance data for each path, the shortest path comprising a path having at least one of a shortest average welk time or a shortest distance between the source location and the destination location;
record distance data associated with the shortest path within a distance matrix;
generate routing instructions for traveling from the source location to the destination location along the shortest path;
obtain image data associated with an obstruction within the shortest path from an image capture device;
calculate updated dynamic distance data for each path in the plurality of possible paths between the source location and the destination location;
identify an updated shortest path in the plurality of possible paths using the updated dynamic distance data; and
record updated distance data associated with the updated shortest path within the distance matrix.

2. The system of claim 1, wherein the instructions are further operative to:
generate updated routing instructions for traveling from the source location to the destination location along the updated shortest path using the updated distance data.

3. The system of claim 1, wherein the instructions are further operative to:
generate a routing map including the shortest path; and
output the routing map to a user via a user interface device for routing the user to the destination location from the source location in a shortest walking distance or within a shortest transit time.

4. The system of claim 1, wherein the instructions are further operative to:
generate driving instructions for driving a vehicle along the shortest path; and
output the driving instructions to a user device for routing the vehicle to the destination location from the source location with a shortest driving distance or within a shortest transit time.

5. The system of claim 1, wherein the instructions are further operative to:
generate instructions for directing a robotic device along the shortest path; and
transmit the instructions to the robotic device via a network, wherein the instructions route the robotic device along the shortest path from the source location to the destination location with a shortest distance or within a shortest transit time.

6. The system of claim 1, wherein the instructions are further operative to:
calculate the average walk time between the source location and the destination location using historical distance data associated with walkable distances between a pair of reference points.

7. The system of claim 1, wherein the instructions are further operative to:
calculate the distance between the source location and the destination location in feet using coordinate data for the source location and the destination location.

8. A method for dynamic distance-based routing using a distance matrix, the method comprising:
calculating an average walk time from a source location to a destination location associated with each path in a plurality of possible paths between the source location and the destination location using per-store distance data, the per-store distance data comprising historical distance data;
calculating a physical distance between the source location and the destination location using a set of coordinates for the source location and a set of coordinates for the destination location;
identifying a shortest path in the plurality of possible paths using the calculated average walk time and the calculated physical distance associated with each path, the shortest path comprising a path having at least one of a shortest average welk time or a shortest distance between the source location and the destination location;
generating routing instructions for traveling from the source location to the destination location along the shortest path, wherein the routing instructions are presented to a user via a user interface device;
obtaining real-time image data associated with a new obstruction within the shortest path from an image capture device;
calculating updated average walk time and an updated physical distance associated with each path dynamic distance data for each path in the plurality of possible paths between the source location and the destination location using the real-time image data;
identifying an updated shortest path in the plurality of possible paths using the updated average walk time and the updated physical distance associated with each path; and
recording updated distance data associated with the updated shortest path within the distance matrix.

9. The method of claim 8, further comprising:
generating updated routing instructions for traveling from the source location to the destination location along the updated shortest path, the updated routing instructions including a map; and
presenting the map to a user via a user interface device, wherein the map includes a graphic representation of the updated shortest path directing the user to travel from the source location to the destination location along the updated shortest path.

10. The method of claim 8, further comprising:
performing computer vision analysis by a machine learning model to identify the new obstruction using the real-time image data.

11. The method of claim 8, further comprising:
identifying a plurality of source-to-destination pairs;
calculating the average walk time and physical distance between each path in a plurality of paths corresponding to each source-to-destination pair in the plurality of source-to-destination pairs;
selecting a shortest path from the plurality of paths for each source-to-destination pair in the plurality of source-to-destination pairs; and
recording the average walk time and the physical distance associated with the selected shortest path for each source-to-destination pair in the distance matrix.

12. The method of claim 8, further comprising:
obtaining image data from a plurality of image capture devices associated with a plurality of robotic devices, wherein the image data is analyzed to identify permanent obstructions and temporary obstructions.

13. The method of claim 8, further comprising:
generating distance data associated with a plurality of shortest paths for traveling from a selected source location to a plurality of different destination locations; and
updating the distance matrix with the distance data for each source-to-destination pair associated with the source location and the plurality of different destination locations, wherein the distance data comprises the average walk time and the physical distance calculated for each source-to-destination pair.

14. The method of claim 8, further comprising:
generating distance data associated with a plurality of shortest paths for traveling from a plurality of different source locations to a selected destination location; and
updating the distance matrix with the distance data for each source-to-destination pair associated with the plurality of different source locations and the selected destination location, wherein the distance data comprises the average walk time and the physical distance calculated for each source-to-destination pair.

15. One or more computer storage devices having computer-executable instructions stored thereon, which, upon execution by a computer, cause the computer to perform operations comprising:
obtaining image data associated with a plurality of obstructions;
identifying a location of each obstruction in the plurality of obstructions using the image data and item assortment data;
calculating dynamic distance data for each path in a plurality of possible paths between a source location and a destination location using per-store distance data and the location of each obstruction in the plurality of obstructions, the dynamic distance data comprising an average walk time from the source location to the destination location and a distance between the source location and the destination location;
identifying a shortest path in the plurality of possible paths using the dynamic distance data for each path, the shortest path comprising a path having at least one of a shortest average welk time or a shortest distance between the source location and the destination location;
recording distance data associated with the shortest path within a distance matrix;
generating routing instructions for traveling from the source location to the destination location along the shortest path using distance data in the distance matrix; and
providing the routing instructions to a user via a user interface device, wherein the user is routed from the source location to the destination location along the shortest path via the routing instructions.

16. The one or more computer storage devices of claim 15, wherein the operations further comprise:
obtaining updated image data associated with a new obstruction within the shortest path from an image capture device;
calculating updated dynamic distance data for each path in the plurality of possible paths between the source location and the destination location;
identifying an updated shortest path in the plurality of possible paths using the updated dynamic distance data; and
recording updated distance data associated with the updated shortest path within the distance matrix.

17. The one or more computer storage devices of claim 15, wherein the operations further comprise:
calculating the distance between the source location and the destination location in feet using coordinate data for the source location and the destination location.

18. The one or more computer storage devices of claim 15, wherein the operations further comprise:
calculating the average walk time between the source location and the destination location using historical distance data associated with walkable distances between a pair of reference points.

19. The one or more computer storage devices of claim 15, wherein the operations further comprise:
generating driving instructions for driving a vehicle along the shortest path; and
presenting the driving instructions to a user device for routing the vehicle to the destination location from the source location with a shortest driving distance or within a shortest transit time.

20. The one or more computer storage devices of claim 15, wherein the operations further comprise:
generating a routing map including the shortest path; and
presenting the routing map to a user via a user interface device for routing the user to the destination location from the source location in a shortest walking distance or within a shortest transit time.
